(19) United States
(12) Patent Application Publication
(10) Pub. No.: US 2018/0020076 A1
(43) Pub. Date: Jan. 18, 2018

(54) ELECTRONIC AND MOBILE PLATFORM TO CREATE, STORE AND EXCHANGE BUSINESS CARDS

(71) Applicant: Abhinav Porwal, Warren, NJ (US)

(72) Inventor: Abhinav Porwal, Warren, NJ (US)

(21) Appl. No.: 15/719,306

(22) Filed: Sep. 28, 2017

Related U.S. Application Data
(63) Continuation-in-part of application No. 15/530,672, filed on Apr. 25, 2016.

(51) Int. Cl. H04L 29/08; G06F 17/30; G06Q 10/10; G06Q 50/00

(52) U.S. Cl. CPC H04L 67/306; G06Q 50/01; G06F 17/30312; G06Q 10/10

(57) ABSTRACT

A system and method of generating and sharing virtual business cards. A physical business card is inputted into the system which identifies text and design elements. The physical business card is reproduced as a virtual digital business card by converting printed text on the scanned business card into editable text fields, and converting printed design elements into editable digital design elements. The text and associated design elements are then stored according to certain preset criteria and contact details from the text are populated into a contacts database. A user can share a virtual business card with one or more recipients. If accepted, the shared virtual business card populates contact details from the card into a contacts database of the recipient. Moreover, the virtual business card is updated for each recipient when changes are made to the virtual business card by an authorized entity.

### CROSS-REFERENCE TO RELATED APPLICATIONS

This application is a Continuation-in-Part of U.S. patent application Ser. No. 15/530,672 filed on Apr. 25, 2016 which is incorporated herein by reference in its entirety.

### FIELD OF THE INVENTION

The present invention generally relates to electronic and mobile platforms for creating, storing and exchanging business cards.

### BACKGROUND

Business cards have traditionally been created on a rectangular piece of card stock and exchanged physically. There are providers that specialize in design and production of business cards, as well as users who design and print cards themselves for personal use. The do-it-yourself approach usually results in average quality cards that then need to be cut with precision using special equipment. If not, they often look amateurish.

At present, most business card/contact information exchanges take place manually. There is a limit to the number of cards that can be carried conveniently, and receivers lose or misplace the cards very often. If any of the information changes, cards need to be re-printed and re-distributed.

Business and personal contact information is also being shared electronically in a semi-organized fashion by exchanging “contact cards” through smartphones. The information is very basic, hard to organize by different attributes and lacks the look and feel of a physical business card. Again, once the information has been exchanged, there is no “automatic update” if any of the information changes.

Therefore, there is need in the art for a system and method that can generate, search for, organize, browse, share, and automatically update virtual business cards within an intuitive, easy-to-use graphical user interface environment. These and other features and advantages of the present invention will be explained and will become obvious to one skilled in the art through the summary of the invention that follows.

### SUMMARY OF THE INVENTION

Accordingly, it is an object of the present invention to provide a system and method for generating, modifying, and sharing virtual business cards.

According to an embodiment of the present invention, a system for generating and providing virtual business cards includes: a business card generation module, comprising computer-executable code stored in non-volatile memory; a processor; and a communications means, wherein said business card generation module, said processor, and said communications means are operably connected and are configured to: accept a scanned or photographed business card as input; identify text and associated design elements on the inputted business card; store the text data and associated design elements according to preset criteria; automatically populate contact details from the inputted business card into one or more of a user's contact databases; share the business card with one or more recipients; automatically populate contact details from the shared business card into a contacts database of the recipient(s).

According to an embodiment of the present invention, the business card generation module, processor, and communications means are further configured to: display a gallery of customizable business card templates from which a user can select; allow a user to enter text and design elements in a selected business card template; preview the completed business card; store the completed business card according to preset criteria; automatically populate contact details from the newly created business card into one or more of a user's contact databases; share the business card with one or more recipients; automatically populate contact details from the shared business card into a contacts database of the recipient(s).

According to an embodiment of the present invention, the preset criteria are selected from the group comprising business name, person name, type of business, type of product or service, newest card, oldest card, rating, location.

According to an embodiment of the present invention, the business card generation module, processor, and communications means are further configured to: dynamically update a business card in a user's collection when the issuer of the card or other authorized entity makes a change to the card.

According to an embodiment of the present invention, a unique identifier, such as a PIN, is used to identify users who are authorized to receive a business card.

According to an embodiment of the present invention, the business card generation module, processor, and communications means are further configured to: receive a business card search request from a user; identify one or more business cards that match the request; retrieve and display the business card results to the user.

According to an embodiment of the present invention, the business card generation module, processor, and communications means are further configured to: activate one or more widgets in response to a user clicking a link on the business card.

According to an embodiment of the present invention, the business card generation a module, processor, and communications means are further configured to: retrieve World Wide Web content associated with the business card; and provide the content to the user, where the content includes data that alters the business card when the retrieved content is more recent than content on the business card.

According to an embodiment of the present invention, a method for generating and sharing virtual business cards, the method includes: receiving a scanned or photographed business card as input; identifying text and associated design elements on the inputted business card; storing the text data and associated design elements according to preset criteria; automatically populating contact details from the inputted business card into one or more of a user's contact databases; sharing the business card with one or more recipients; automatically populating contact details from the shared business card into a contacts database of the recipient(s).

According to an embodiment of the present invention, the method further includes the steps of: displaying a gallery of customizable business card templates from which a user can select; allowing a user to enter text and design elements in a selected business card template; previewing the completed business card; storing the completed business card according to preset criteria; automatically populating contact details from the newly created business card into one or more of a user's contact databases; sharing the business card with one or more recipients; automatically populating contact details from the shared business card into a contacts database of the recipient(s).

According to an embodiment of the present invention, the preset criteria are selected from the group comprising business name, person name, type of business, type of product or service, newest card, oldest card, rating, location.

According to an embodiment of the present invention, the method further includes the steps of: dynamically updating a business card in a user's collection when the issuer of the card or other authorized entity makes a change to the card.

According to an embodiment of the present invention, a unique identifier, such as a PIN, is used to identify users who are authorized to receive a business card.

According to an embodiment of the present invention, the method further includes the steps of: receiving a business card search request from a user; identifying one or more business cards that match the request; retrieving and displaying the business card results to the user.

According to an embodiment of the present invention, the method further includes the steps of: activating one or more widgets in response to a user clicking a link on the business card.

According to an embodiment of the present invention, the method further includes the steps of: retrieving World Wide Web content associated with the business card; and providing the content to the user, where the content includes data that alters the business card when the retrieved content is more recent than content on the business card.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic view of a process flow, in accordance with embodiments of the present invention.

FIG. 1A is a schematic view of a computing device, in accordance with embodiments of the present invention.

FIG. 2 is a schematic view of a network, in accordance with embodiments of the present invention.

FIG. 2A is another schematic view of a network, in accordance with embodiments of the present invention.

FIG. 2B is a network schematic of a system, in accordance with embodiments of the present invention.

FIG. 3 is a schematic view of a graphical user interface for a virtual business card, in accordance with embodiments of the present invention.

FIG. 4 is schematic view of a graphical user interface for editing a virtual business card, in accordance with embodiments of the present invention.

FIG. 5 is a schematic view of a graphical user interface for adding information and a logo to the virtual business card, in accordance with embodiments of the present invention.

FIG. 6 is a schematic view of a graphical user interface for selecting a business card template from a gallery, in accordance with embodiments of the present invention.

Like reference symbols in the various drawings indicate like elements.

### DETAILED DESCRIPTION OF ILLUSTRATIVE EMBODIMENTS

A system and method for generating virtual business cards that can be sent to any saved contact in a contacts database or electronic rolodex. A control server is configured to execute computer readable instructions that generate the virtual business card using pre-stored design templates or by using an input device such as a scanner to scan a physical business card and convert the physical card into an electronic virtual business card. The virtual business card includes a plurality of data fields as well as design elements, such as an uploaded or user designed logo. The virtual business card of the present invention may be sent to any existing user of the business card application or “app” of the present invention and data from the received business card may be automatically populated into a recipient's computer or mobile device contacts database.

The business card application of the present invention provides a user with multiple options for creating and organizing their virtual business cards. As discussed above, a user may scan a physical business card into the application using a proprietary graphical user interface (GUI) generated by a specially configured processor, such as a processor that is part of a control server. An optical character recognition (OCR) module or other text and/or graphic recognition module identifies text fields and data associated with those fields printed on the business card, as well as any design elements and logos. A virtual business card resembling the original physical card is thus created and the data from the card is stored in a database, such as an electronic database native to the business card application, a central database, or distributed across several databases.

Alternatively, the GUI provides a user with the option to create a new virtual business card by selecting a business card template from a database of templates and filling in data fields, such as Company Name, Company Address and Phone Number, Email Address, Name, Title, etc. A business logo and other decorative elements may be uploaded as one or more images displayed on the virtual business card. The GUI also provides a user the option to create a logo using a graphic design tool or to edit an existing logo.

Accordingly, it is an object of the present invention to provide a system and method for generating virtual business cards and sharing business card contact information with others.

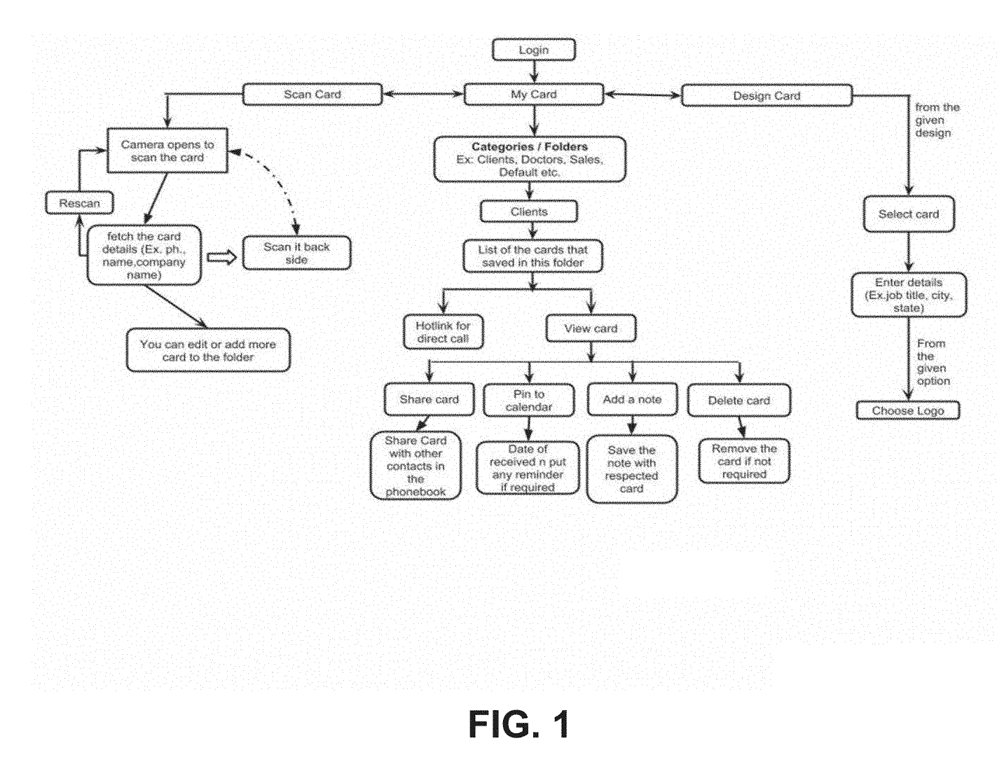

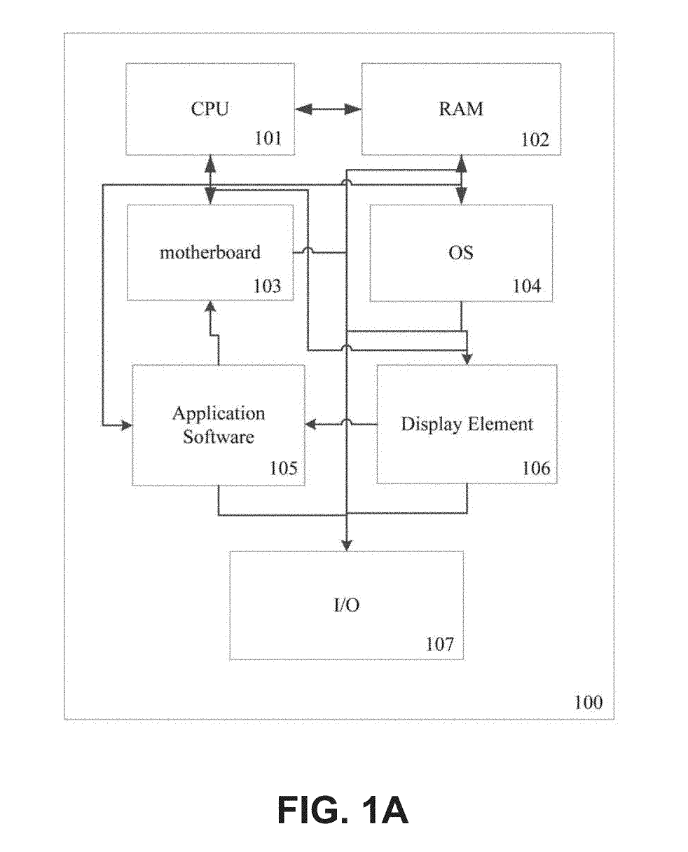

According to an embodiment of the present invention, the system and method is accomplished through the use of one or more computing devices. As shown in FIG. 1A, one of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

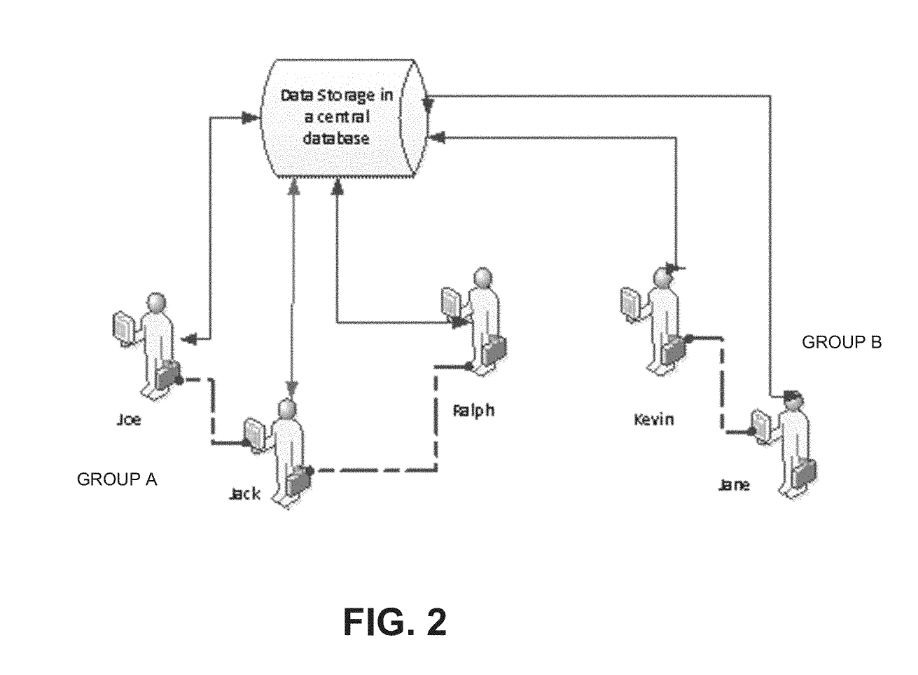

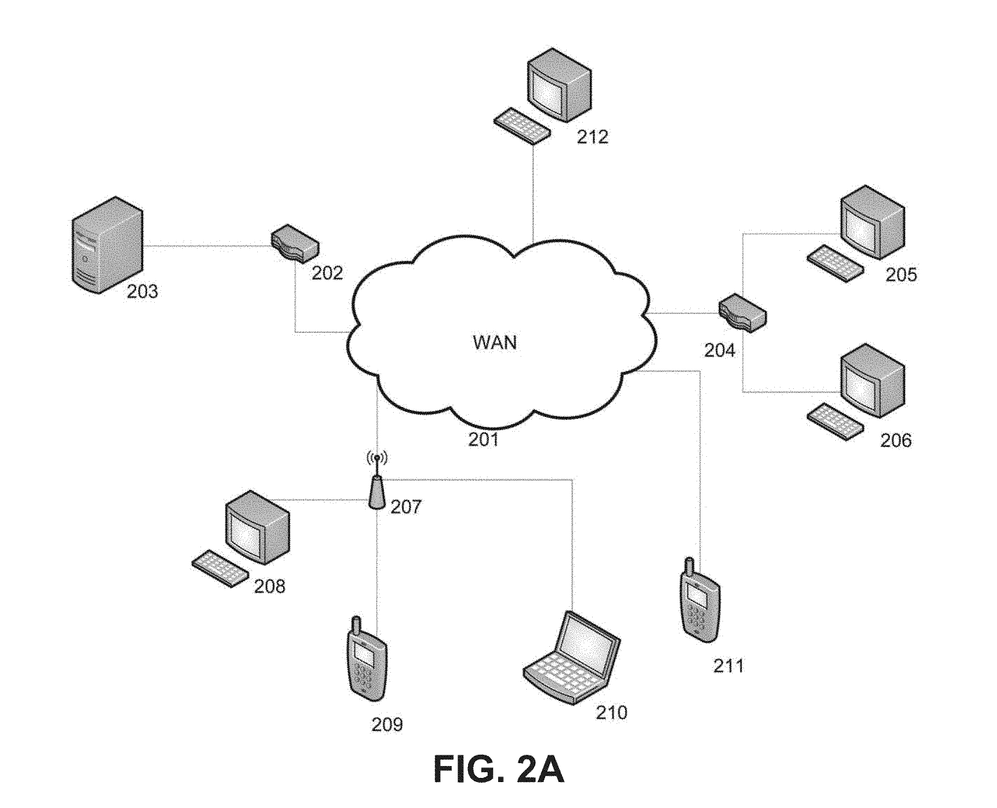

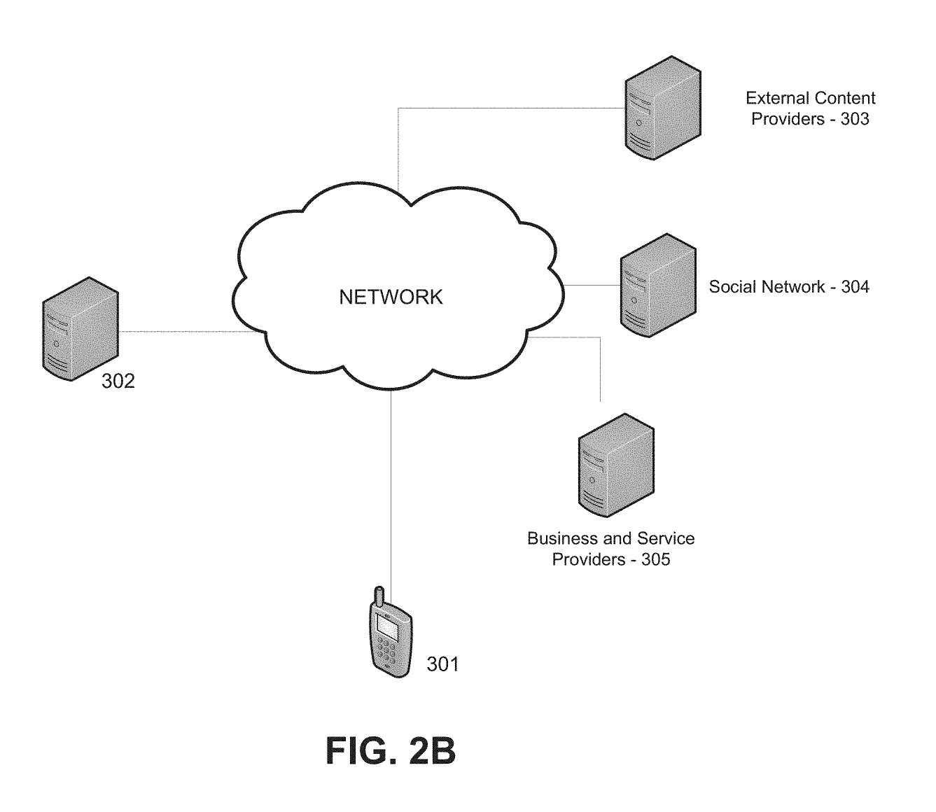

Referring to FIG. 2A, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2A, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

Turning now to FIG. 2B, a continued schematic overview of a system in accordance with an embodiment of the present invention is shown. In FIG. 2B, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of an external content provider API/website or other third party system 303, a social network 304, one or more business and service providers 305 or any combination thereof. Additionally, application server 302 may be able to enhance or otherwise provide additional services to an external content provider API/website or other third party system 303, a social network 304, or one or more business and service providers 305 by providing information to those entities that is stored on a database that is connected to the application server 302. One of ordinary skill in the art would appreciate how accessing one or more third-party systems could augment the ability of the system described herein, and embodiments of the present invention are contemplated for use with any third-party system.

According to an embodiment of the present invention, a system for generating and providing virtual business cards includes: a business card generation module, comprising computer-executable code stored in non-volatile memory; a processor; and a communications means, wherein said business card generation module, said processor, and said communications means are operably connected and are configured to: receive a scanned business card as input and generate a virtual business card therefrom, or generate a new virtual business card by prompting a user to choose a business card template from a gallery of card styles and enter data into data fields in the template; identify, using optical character recognition (OCR) or other text and graphics recognition software, data and design elements displayed on the scanned business card; store and organize data displayed on the business card; automatically populate data from the business card into other databases running on one or more computing devices connected to the control server via wired or wireless network; share contact information from the virtual business card with others.

According to an embodiment of the present invention, the business card generation module, processor, and communications means are further configured to: organize business card data based on category such as accountant, plumber, electrician, etc.

According to an embodiment of the present invention, each user may be assigned a unique personal identification number (PIN). In this embodiment, the PIN is used to exchange business card information with other users of the business card application. In other words, a recipient and/or or sender must have a PIN in order to share one or more business cards from their stored collection.

According to an embodiment of the present invention, the business card generation module, processor, and communications means are further configured to: receive a request to generate a virtual business card, provide a user with a gallery of templates from which to choose, prompt the user to enter business card data into predetermined fields, prompt the user to upload a logo or other design elements for display on the business card, store and organize data from the virtual business card according to various criteria, such as type of business, profession, trade, product/service for sale, name, title, location, rating, price, or any other suitable criteria. In addition, the control server is configured to maintain a count of all business cards in a user's collection, and counts according to category.

According to an embodiment of the present invention, the business card generation module, processor, and communications means are further configured to: retrieve one or more business cards in response to a user request; and add one or more business cards to a user's collection of virtual business cards.

According to an embodiment of the present invention, the business card generation module, processor, and communications means are further configured to: automatically update business card information when any information of the card issuer changes. For example, when the issuer or other authorized entity updates the business card using the business card application, the updated business card data is centrally stored and all authorized users see the updated data via their connection to the central storage. In another embodiment, data from the central storage is automatically downloaded into each user's computing devices in response to a signal from the control server to each user's computing device, so that the business card data is updated on any device running the business card application.

The virtual business card can be easily edited through the GUI to add or update information, or may be deleted if it is no longer needed.

A user can use the GUI to select an option to send or share a virtual business card with one or more other user recipients. A designated recipient of a virtual business card has the option to either accept or reject the card. Once the card is accepted, the card is linked to the recipient's contact list. Alternatively, data from the business card is populated and stored in the recipient's contact lists, including for example a recipient's phone contact list. For example, contact lists on a recipient's computing device may acquire the business card data from the business card though an API. On the other hand, if the card is rejected the sender of the card is notified.

In one embodiment, when a user receives an electronic business card from a sender using the business card app, the card is stored in a New Cards queue (with a pending number count). The terms “electronic business card” and “virtual business card” shall be regarded as equivalent terms and may be used interchangeably throughout this application. Similarly, the terms “application” and “app” shall be regarded as equivalent terms and used interchangeably.

Once a card has been accepted by a recipient, it can be automatically stored in a specific folder. For example, cards for people belonging to the same company can be automatically saved into the same folder assigned to the company. Cards can also be organized according to profession, trade, business type, etc. which allows contacts to be grouped according to the skills or services being offered, such as ‘Plumber’, ‘Lawn Maintenance’, ‘Accountant’, etc.

A plurality of business card categories may be provided by the business card application, but new custom categories may also be created by a user.

According to one embodiment, a user can either scan or take a picture of a physical Business Card and load it into the business card app. The application then automatically tags all the data detected in the image using OCR or other text recognition software tools. The card is thus converted into a virtual business card that can be edited as needed and stored as a card image and related data tags.

The acquired text from the scanned or photographed business card may include details such as Job Title, Company, etc. which are stored as text elements. Logos and other design elements are stored as image files. This allows users to gather and record details (i.e. both text and image details) that may not be listed on the physical business card.

Once a business card is loaded into the app, it can be organized by being saved in a specific folder. This can be done automatically according to some preset criteria, such as company name, business type, products or services, etc., or the user may save the card to any folder he or she chooses.

Cards for people belonging to the same company can be organized into the same folder. Cards can also be organized by ‘role’ which allows contacts to be grouped by their skills or services they offer, like ‘Plumber’, ‘Lawn Maintenance’, ‘Accountant’, etc. Some categories shall be available by default, but new custom categories can be created by the user.

According to an embodiment of the present invention, a user can create a phone contact with the touch of a button from any card stored on the App. They can also place phone calls directly from within the app. For example, a user can click on a phone icon displayed on the business card, or click on the phone number itself which activates a call widget in the app. The term “click” or “clicking” shall include selecting, such as selecting a link on a touch screen.

According to an embodiment of the present invention, data from a business card is automatically populated into any Contacts application on the user's computing device, such as their phone or tablet.

According to an embodiment of the present invention, the business card app is integrated with email applications on a user's computing devices, such as their phone or tablet, and may also be linked to their social media accounts such as LinkedIn®, Facebook®, etc.

According to an embodiment of the present invention, the business card app provides a GUI option to create business cards in different languages, and further provides the option to translate a card received in one language to another language.

According to an embodiment of the present invention, the GUI provides a simple intuitive card design scheme. A user simply selects a design template and format from a database of card designs and then fills out text fields that appear on the selected card template. The user can also upload their own logo and other design elements onto the card.

According to an embodiment of the present invention, a new user of the business card app first enters their basic contact information and may choose to enter other optional information. The user then selects a design from a gallery of designs available to them in the application. As previously mentioned, the user can upload their own company logo and customize the design. The user can then preview the design before approving and saving it as their “business card.”

According to an embodiment of the present invention, companies can select or create and upload their business card design, which will be linked to their website domain in the App database. Any employee who wishes to create a card for themselves can choose their company name from a drop down GUI menu or other list. The employee receives an authentication email on their work email to validate their identity. Upon authentication, the employee is able to create and use their corporate business card. A designated administrator for the corporate business cards receives notification of the Job Title and Contact details inputted by the employee for validation.

According to an embodiment of the present invention, a user can select hypertext elements on the virtual business card being displayed in the GUI, such as a phone number that activates a widget configured to make a phone call or send a text message, or a widget that sends an e-mail when a user selects an e-mail address, or a widget that shares the business card data with designated recipients when a user selects a share option in the GUI.

According to an embodiment of the present invention, a method for generating and providing a virtual business card includes the steps of: accepting as input a scanned or photographed business card; converting the card to a virtual business card with data fields and graphical elements; storing the data in a contacts database associated with the business card application; populating and storing the data in one or more other contact databases of the sender; sharing the business card data with at least one other recipient; populating and storing the business card data in one or more contact databases of the recipient.

According to an embodiment of the present invention, the method further includes the steps of: categorizing business card data according to some criteria, such as business type, name, title, profession, trade, oldest card, newest card, location, rating, price, product/service, etc.

According to an embodiment of the present invention, the method further includes the steps of: receiving a search request from a user; identifying stored content that matches the user's request; retrieving the stored content that matches the user's search criteria; and displaying the matching content in the GUI. The matching content may be displayed as a list of matching content items by company name, individual name, professional/trade/artisan category, and/or geographic location, address, phone number, product/service, or any combination thereof. The user can then select a desired content item from the list and the selected item is displayed as a virtual business card in the GUI. Alternatively, all matching content items may be displayed as one or more virtual business cards from which the user may select.

According to an embodiment of the present invention, the method further includes the steps of: retrieving other data or links associated with a virtual business card, such as a company website, Facebook® page, Twitter® feed, news about the company, promotions, locations, or other information about the business card issuer.

According to an embodiment of the present invention, the method further includes the steps of: automatically updating content displayed on a virtual business card whenever the issuer of the business card or other authorized entity uses the GUI to update information on the business card. The updated or changed business card content is stored in a central storage accessible by all business card application users via a network. Alternatively, the updated data is automatically downloaded by each user's computing device(s) when an update signal is sent to the respective devices from the control server. In addition, other contact databases, such as phone contacts, on each user's device are also updated with the updated content through an API.

In one exemplary embodiment of the invention a designated recipient of a virtual business card has the option to either accept or reject the card. Once the card is accepted, the card is linked to the recipient's contact list. Alternatively, data from the business card is populated and stored in the recipient's contact lists, including for example a recipient's phone contact list. For example, a contact list on a recipient's computing device may acquire the business card data from the business card application though an API. If the card is rejected, the sender of the virtual business card is notified.

In another exemplary embodiment the business card application is integrated with calendar software on a user's computer device through, for example, an API. The calendar application can acquire data from the business card for purposes of setting up appointments and the like.

Turning to the Figures, FIG. 1 is a data flow diagram 100 that shows how business card information is acquired by the business card application and FIGS. 2A-2B show how business card data is stored in a central database on, for example, a control server. Whenever a user updates their information in the application, the update gets pushed to the central database, and gets pushed to all the other authorized users that are “connected” to that user through the control server. The app may use a PIN, for example, to determine which users are authorized users. In an alternate embodiment, business card data is accessible across a distributed network. In such an embodiment, there is no need for a central database since data is shared across the network of users.

As shown in FIG. 1 a user logs into the business card application and has the option of accessing their existing virtual business card, or scanning/designing a new business card. Although Applicant refers to “scanning” the business card using, for example, a scanner, the term “scanning” and “scan” shall include photographing the business card or any other way of digitally reproducing the business card for input into the business card application program. Once the business card has been scanned into the application, the application may use OCR or other text and graphics recognition software to identify and acquire card details such as company name, card holder name, logo, address, phone number, e-mail, etc.

The user also has the option of designing a new business card using design tools provided by the business card application. In this embodiment, the GUI includes a gallery of design templates from which the user can choose. Once a design template is selected, the user can enter their business card details into various text fields of the business card template. In addition, the user can upload design elements such as a logo into a frame element that displays the logo image. The new design can then be saved in a selected folder, or is automatically saved according to some criteria, such as category/type of business, type of product or service, name of the business or individual listed on the card, oldest card, newest card, rating, location, etc.

If the user has an existing business card stored in the central database the user can access the card by various means, including navigating to the folder in which the card resides, inputting search criteria into the GUI to find the desired business card, or scrolling through a list of business cards. One of ordinary skill will recognize that the list of business cards may be a simple text list, a list of business card images, or thumbnail images. A user reviewing the list of business cards can click a link associated with each listed card that activates a call widget. Alternatively, the user can select a virtual business card and click on the phone number which is displayed as a hypertext link. Clicking on the phone number activates the call widget. The term “call” includes both voice and text communications, as is well known to someone of ordinary skill in the art. In a similar fashion, the user can click on an e-mail address to activate an e-mail widget that opens an e-mail program.

When a user opens a virtual business card the application presents the user with a plurality of options in a GUI. The options include, but are not limited to: (1) share the business card, (2) pin the business card to a calendar, (3) add a note to the business card, and (4) delete the card. The share option allows a user to share one or more virtual business cards with any other contacts in their contacts database. The calendar pinning option pins an image of the business card to a selected calendar date. The pinning option can also be used to schedule an appointment using the data in the virtual card. The “add a note” option allows a user to save a note to the virtual business card. For example, the user can type a note which is saved in a notes subfolder of the business card. The note may then appear as a graphic or icon on the virtual card which may be opened in any number of ways, such as by hovering a mouse pointer over the icon, selecting the icon, or double clicking the icon. The delete option allows a user to delete a virtual business card from its storage location.

FIG. 2 illustrate how business card data from a plurality of users is stored in a central database. Although a central database is shown in the Figure, one of ordinary skill will recognize that data may be stored among several storage devices in a distributed network, or in the cloud. In the exemplary embodiment of FIG. 2 two groups of users are operating mobile devices connected to a central storage through a network. Group A includes 3 users who have exchanged business card data with each other, as represented by broken lines. Group B includes 2 users who have exchanged business card data, also represented by a broken line. However, members of Group A have no access to business card data of members of Group B and vice-versa since there is no link (i.e. broken line) between them.

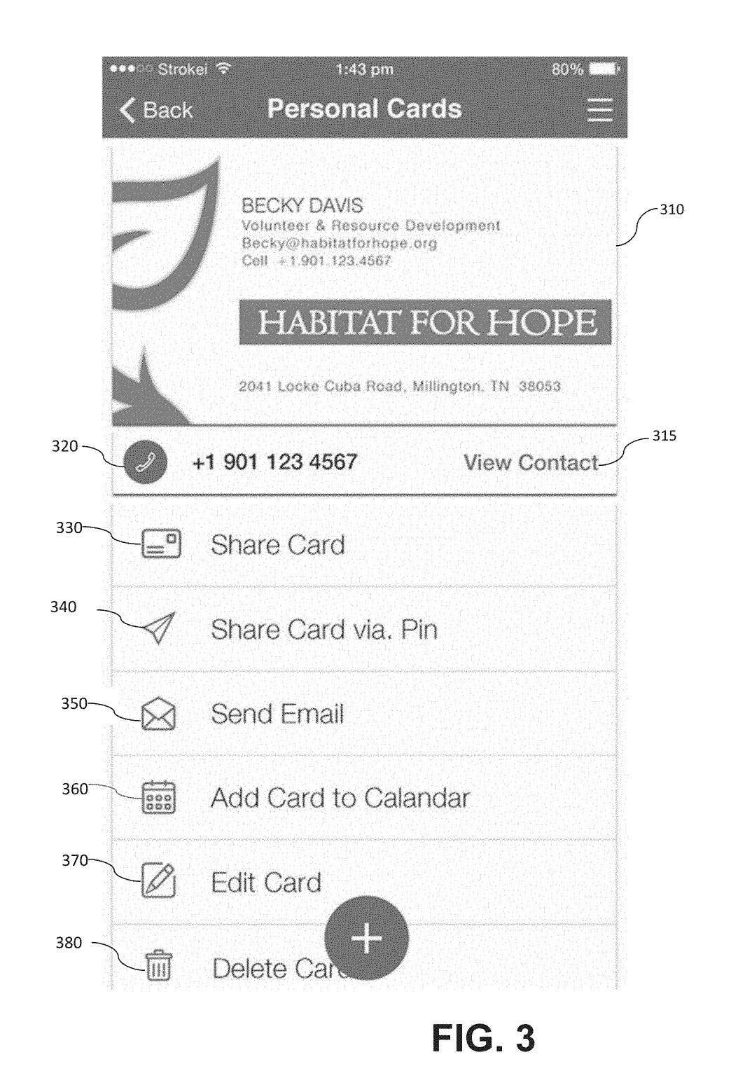

FIG. 3 shows an exemplary virtual business card 310 displayed on a user's computing device. As can be seen, the virtual business card is part of a GUI that includes several useful options or widgets, including a “View Contact” option 315, a call widget 320, a “Share Card” widget 330, a “Share Card via Pin” 340 widget, a “Send Email” widget 350, an “Add Card to Calendar” widget 360, an “Edit Card” option 370, and a “Delete Card” option 380.

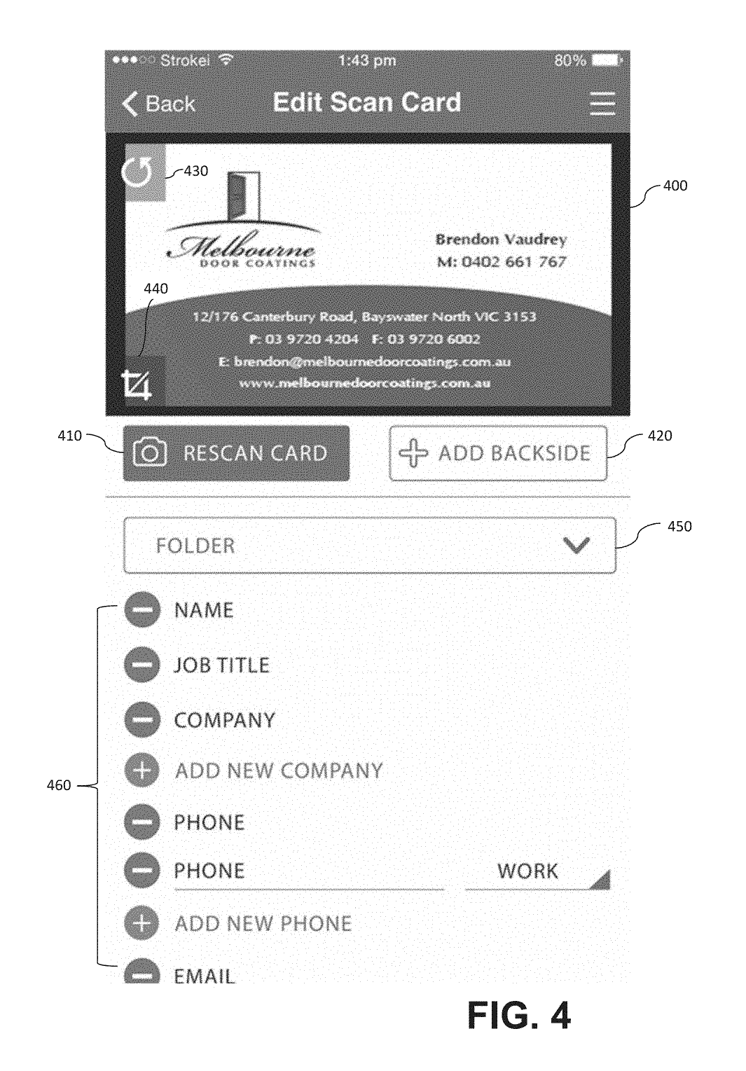

FIG. 4 shows the edit card screen in the GUI. The edit card screen includes a virtual business card 400 displayed on a user's computing device, a “Rescan Card” 410 button and an “Add Backside” 420 button. The Rescan Card button allows a user to re-scan or photograph the card. The Add Backside button allows a user to scan or photograph the backside of the business card which is automatically linked to the front side of the business card. A flip card option 430 allows a user to view the backside of a business card, if any. An enlarge option 440 allows a user to magnify the image of the business card currently being viewed.

FIG. 4 further illustrates a drop down list of folders 450 in which the business card can be saved. In addition, the GUI shows formatting options in the form of text fields 460 that can be added or deleted from the virtual card. A plus sign indicates that the field is to be added, while a minus sign indicates that the field is to be deleted.

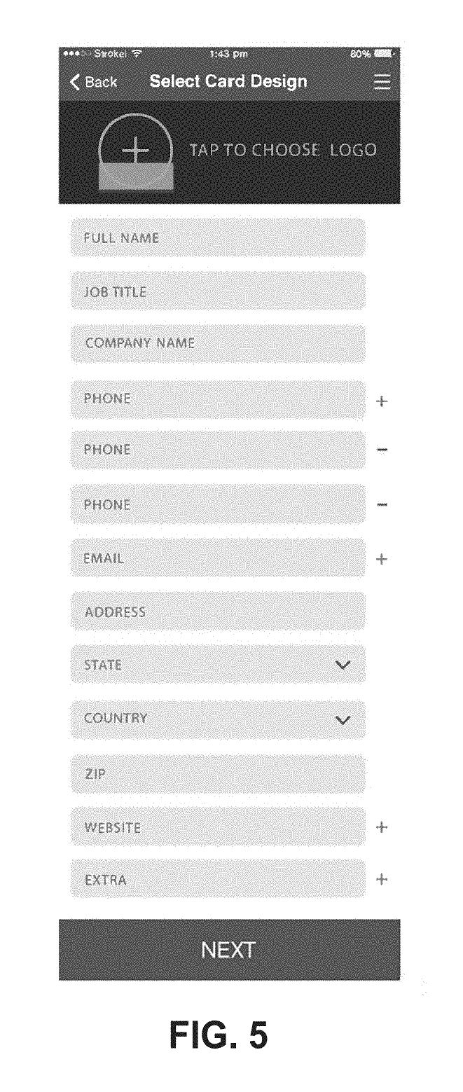

FIG. 5 illustrates the GUI screen in which a user adds details to the business card, such as text or a logo. In this screen, the user can add a logo to the card by navigating to the logo's storage location and uploading it into an image frame on the business card. The user can also fill in the text fields to provide information for the virtual business card.

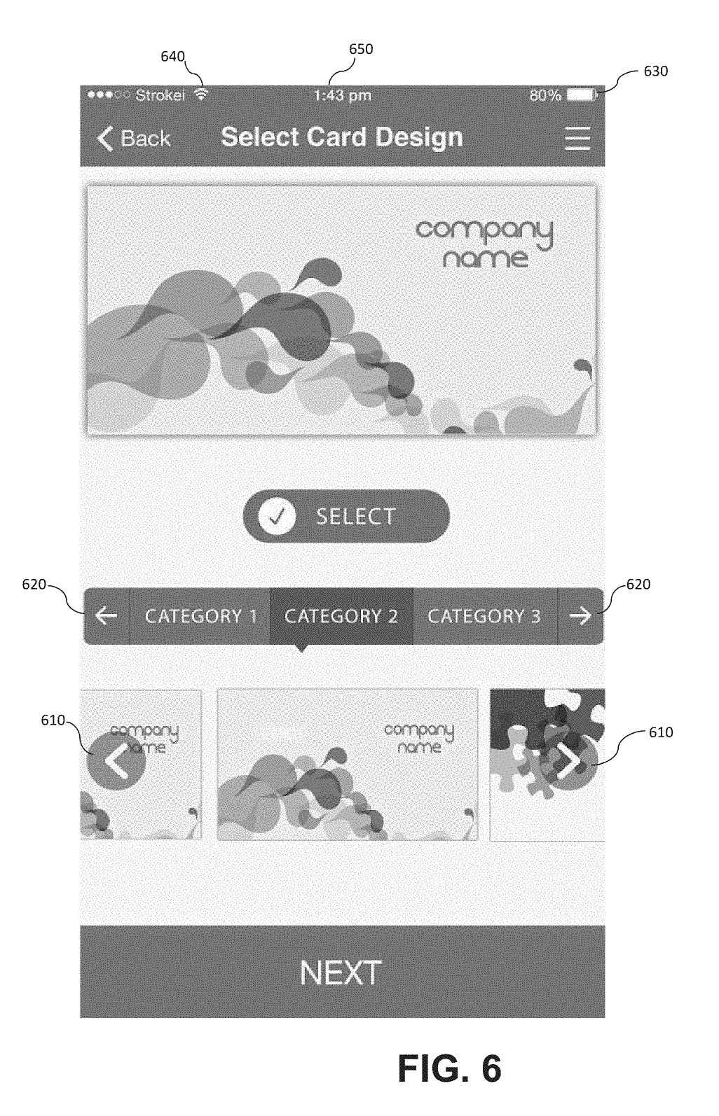

FIG. 6 illustrates the GUI screen for selecting a card design from the built-in gallery of design templates. The user can scroll through and select from various design template options using the arrows 610, or scroll through categories of design templates by using arrows 620. The currently viewed card from the gallery of card styles is displayed in an enlarged mode 660.

Many other features and indicators may be included in the GUI, such as battery power indicator 630, signal strength indicator 640, current time 650, etc. A person of ordinary skill in the art will recognize that many features and indicators besides those illustrated in the figures can be included in the GUI.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

What is claimed is:

1. A system for generating and sharing virtual business cards, the system comprising:
a business card generation module, comprising computer-executable code stored in non-volatile memory;
a processor; and
a communications means,
wherein said business card generation module, said processor, and said communications means are operably connected and are configured to:
receive a scanned business card as input;
identify text and design elements on said business card;
reproduce the scanned business card as a virtual digital business card by at least
converting printed text on the scanned business card into editable text fields, and
converting printed design elements on the scanned business card into editable digital design elements;
store text and associated design elements according to preset criteria;
populate contact details from the virtual business card into a contacts database;
share the virtual business card with one or more recipients;
populate contact details from the virtual business card into a contacts database of the recipient,
wherein the virtual business card is automatically updated for each recipient when changes are made to the virtual business card by an authorized entity.

2. The system of claim 1, wherein said editable digital design elements comprise one or more image frames for receiving and displaying one or more digital images.

3. The system of claim 1, wherein said business card generation module, said processor, and said communications means are operably connected and are further configured to:
generate a graphical user interface (GUI) for creating a new virtual business card,
said GUI comprising:
a gallery of selectable business card templates that include text fields for receiving and displaying inputted text and an image frame for receiving and displaying an image.

4. The system of claim 3, wherein said GUI further comprises a selectable option for sharing a virtual business card with one or more recipients.

5. The system of claim 3, wherein said GUI further comprises a selectable option for e-mailing a contact displayed on the card.

6. The system of claim 3, wherein said GUI further comprises a selectable option for linking a virtual business card to a date on an electronic calendar.

7. The system of claim 3, wherein said GUI further comprises a selectable option for scheduling an appointment with an entity listed on the virtual business card.

8. The system of claim 7, wherein said appointment is scheduled by clicking a link displayed on the virtual business card.

9. The system of claim 3, wherein said GUI further comprises a selectable option for editing a virtual business card.

10. The system of claim 3, wherein said GUI further comprises a selectable option for deleting a virtual business card.

11. The system of claim 3, wherein said GUI comprises a selectable option for scanning a business card.

12. The system of claim 11, wherein said GUI comprises a selectable option for scanning a reverse side of the business card.

13. The system of claim 3, wherein said GUI includes a window for viewing and editing a virtual business card.

14. The system of claim 13, wherein said GUI comprises a selectable option for viewing and editing a reverse side of the virtual business card.

15. The system of claim 3, wherein said GUI comprises a selectable option for adding at least one of a text field, image, and design element to a virtual business card.

16. The system of claim 1, wherein said preset criteria are selected from the group comprising: business type, name, title, profession, trade, oldest card, newest card, location, rating, price, and product or service.

17. The system of claim 1, the business card generation module, processor, and communications means are further configured to activate one or more widgets in response to a user clicking a link on the business card.

18. The system of claim 17, wherein said one or more widgets are selected from the group comprising: a call widget, an e-mail widget, a share card widget, and an add card to calendar widget.

19. A method of generating and sharing virtual business cards, the method comprising:
receiving a scanned business card as input;
identifying text and design elements on said business card;
reproducing the scanned business card as a virtual digital business card by at least
converting printed text on the scanned business card into editable text fields, and
converting printed design elements on the scanned business card into editable digital design elements;
storing text and associated design elements according to preset criteria;
populating contact details from said virtual business card into a contacts database;
sharing said virtual business card with one or more recipients;
populating contact details from said virtual business card into a contacts database of the recipient,
wherein the virtual business card is automatically updated for each recipient when changes are made to the virtual business card by an authorized entity.

20. The method of claim 19, wherein said editable digital design elements comprise one or more image frames for receiving and displaying one or more digital images.
